(19) United States
(12) Patent Application Publication
(10) Pub. No.: US 2013/0206368 A1
(43) Pub. Date: Aug. 15, 2013

(54) COOLING DEVICE AND METHOD FOR PRODUCING THE SAME

(71) Applicants: Minoru Yoshikawa, Tokyo (JP); Hitoshi Sakamoto, Tokyo (JP); Masaki Chiba, Tokyo (JP); Kenichi Inaba, Tokyo (JP); Arihiro Matsunaga, Tokyo (JP)

(72) Inventors: Minoru Yoshikawa, Tokyo (JP); Hitoshi Sakamoto, Tokyo (JP); Masaki Chiba, Tokyo (JP); Kenichi Inaba, Tokyo (JP); Arihiro Matsunaga, Tokyo (JP)

(73) Assignee: NEC CORPORATION, Tokyo (JP)

(21) Appl. No.: 13/880,252

(22) PCT Filed: Oct. 14, 2011
(86) PCT No.: PCT/JP2011/074236

§ 371 Date: Apr. 18, 2013

(30) Foreign Application Priority Data
Oct. 19, 2010 (JP) 2010-234359

(51) Int. Cl. F28D 15/02; B23P 15/26

(52) U.S. Cl. CPC F28D 15/02; B23P 15/26
USPC 165/104.21; 29/890.035

(57) ABSTRACT

In a cooling device using an ebullient cooling system, the cooling performance adversely decreases if the evaporator includes projections activating the convection heat transfer and the bubble nuclei are formed on the inner wall surface, therefore, a cooling device according to an exemplary aspect of the invention includes an evaporator storing a refrigerant; a condenser condensing and liquefying a vapor-state refrigerant vaporized in the evaporator and radiating heat; and a connection connecting the evaporator and the condenser; wherein the evaporator includes a base thermally contacting with an object to be cooled, and a container; the base includes a plurality of projections on a boiling surface of a surface at an inner wall side contacting with the refrigerant; and a bubble nucleus forming surface is included only on a part of a refrigerant contacting surface including the boiling surface and the surface of the projections.

### TECHNICAL FIELD

The present invention relates to cooling devices for semiconductor devices and electronic devices and the like, in particular, to a cooling device and a method for producing the same using an ebullient cooling system in which the heat transportation and heat radiation are performed by a cycle of vaporization and condensation of a refrigerant.

### BACKGROUND ART

In recent years, with the progress of high performance and high functionality in semiconductor devices and electronic devices, the amount of heat generation from them is increasing. On the other hand, the miniaturization of semiconductor devices and electronic devices is advancing due to the popularization of portable devices. Because of such background, a cooling device with high efficiency and a small size is highly required. The cooling device using an ebullient cooling system in which the heat transportation and heat radiation are performed by a cycle of vaporization and condensation of a refrigerant, is expected as a cooling device for the semiconductor devices and the electronic devices because it does not require any driving unit such as a pump.

An example of the cooling device using an ebullient cooling system (hereinafter, also denoted as the ebullient cooling device) is described in the patent literature 1. The ebullient cooling device described in the patent literature 1 includes an evaporator which stores a liquid phase refrigerant, and a condenser which condenses and liquefies the refrigerant steam evaporated by the heat received from a body to be cooled in the evaporator and radiates the heat. The evaporator includes cuboids convex parts made of the same material as a boiling surface on the boiling surface at the side of the inner wall in contact with the liquid phase refrigerant. And a blasting treatment is processed using an abrasive material for all over the surface of the top surface and lateral surface of the convex parts and the flat surface other than the convex parts.

As shown in FIG. 8, in an evaporator 310 configuring the related ebullient cooling device described in the patent literature 1, a boiling surface 313 and whole surface of convex parts 314 are roughened by processing the blasting treatment, and bubble nuclei 315 which become source nuclei of bubbles are formed all over the surface. It is said that, for that reason, the generation of the bubbles becomes much more frequent on the surfaces of an inner wall 316, and an efficient boil arises successively. Further, in addition to obtaining an effect of enhancing heat transfer because the convex parts 314 act as fins as the projections, it is possible to obtain an effect that the area to be processed by the blasting treatment increases and bubble nuclei increase due to including the convex parts (projections) 314. It is said that, with all these factors, according to the ebullient cooling device in the patent literature 1, it is possible to obtain the ebullient cooling device with excellent cooling performance because of the improvement in the boiling heat-transfer coefficient.

Patent Literature 1: Japanese Patent Application Laid-Open Publication No. 2003-139476 (paragraphs [0023] to [0049]).

### DISCLOSURE OF INVENTION

### Problem to be Solved by the Invention

As mentioned above, in the related ebullient cooling device, the bubble nuclei 315 are formed on the boiling surface 313 and all surface of the convex parts (projections) 314 in the evaporator 310. However, because the bubbles generated on the side surfaces of the convex parts (projections) 314 prevent the bubbles generated on the boiling surface 313 from moving, the cooling performance adversely decreases.

As mentioned above, the related ebullient cooling device has a problem that the cooling performance adversely decreases if the evaporator includes projections activating the convection heat transfer and the bubble nuclei are formed on the inner wall surface.

The object of the present invention is to provide a cooling device and a method for producing the same which solve the problem mentioned above that in a cooling device using an ebullient cooling system, the cooling performance adversely decreases if the evaporator includes projections activating the convection heat transfer and the bubble nuclei are formed on the inner wall surface.

### Means for Solving a Problem

A cooling device according to an exemplary aspect of the invention includes an evaporator storing a refrigerant; a condenser condensing and liquefying a vapor-state refrigerant vaporized in the evaporator and radiating heat; and a connection connecting the evaporator and the condenser; wherein the evaporator includes a base thermally contacting with an object to be cooled, and a container; the base includes a plurality of projections on a boiling surface of a surface at an inner wall side contacting with the refrigerant; and a bubble nucleus forming surface is included only on a part of a refrigerant contacting surface including the boiling surface and the surface of the projections.

A method for producing a cooling device according to an exemplary aspect of the invention includes the steps of: forming a plurality of projections on a boiling surface of a surface at an inner wall side contacting with a refrigerant in a base included by an evaporator storing the refrigerant; forming a bubble nucleus forming surface only on a part of a refrigerant contacting surface including the boiling surface and the surface of the projections; forming the evaporator by joining the base to a container; and connecting the evaporator to a condenser condensing and liquefying a vapor-state refrigerant vaporized in the evaporator and radiating heat.

A method for producing a cooling device according to an exemplary aspect of the invention includes the steps of: performing a roughening process on a boiling surface of a surface at an inner wall side contacting with a refrigerant in a base included by an evaporator storing the refrigerant; forming a bubble nucleus including a concavo-convex shape with a size determined by properties of the refrigerant; forming a projection by carving and raising a part of the base from the boiling surface side; forming the evaporator by joining the base to a container; and connecting the evaporator to a condenser condensing and liquefying a vapor-state refrigerant vaporized in the evaporator and radiating heat.

### Effect of the Invention

According to the cooling device of the present invention, it is possible to obtain a cooling device with an ebullient cooling system whose cooling performance is improved.

### BRIEF DESCRIPTION OF THE DRAWINGS

FIG. 1 is a cross-sectional view showing a configuration of a cooling device in accordance with the first exemplary embodiment of the present invention.

FIG. 2 is a plan view showing a configuration of a base of the cooling device in accordance with the first exemplary embodiment of the present invention.

FIG. 3 is a cross-sectional view to illustrate a method for producing the cooling device in accordance with the first exemplary embodiment of the present invention.

FIG. 4A is a cross-sectional view to illustrate the method for producing the cooling device in accordance with the first exemplary embodiment of the present invention.

FIG. 4B is a cross-sectional view to illustrate the method for producing the cooling device in accordance with the first exemplary embodiment of the present invention.

FIG. 4C is a cross-sectional view to illustrate the method for producing the cooling device in accordance with the first exemplary embodiment of the present invention.

FIG. 5 is a cross-sectional view to illustrate another method for producing the cooling device in accordance with the first exemplary embodiment of the present invention.

FIG. 6 is a cross-sectional view showing a configuration of a cooling device in accordance with the second exemplary embodiment of the present invention.

FIG. 7 is a cross-sectional view to illustrate a method for producing a cooling device in accordance with the second exemplary embodiment of the present invention.

FIG. 8 is a cross-sectional view showing a configuration of the related ebullient cooling device.

### DESCRIPTION OF EMBODIMENTS

The exemplary embodiments of the present invention will be described with reference to drawings below.

### The First Exemplary Embodiment

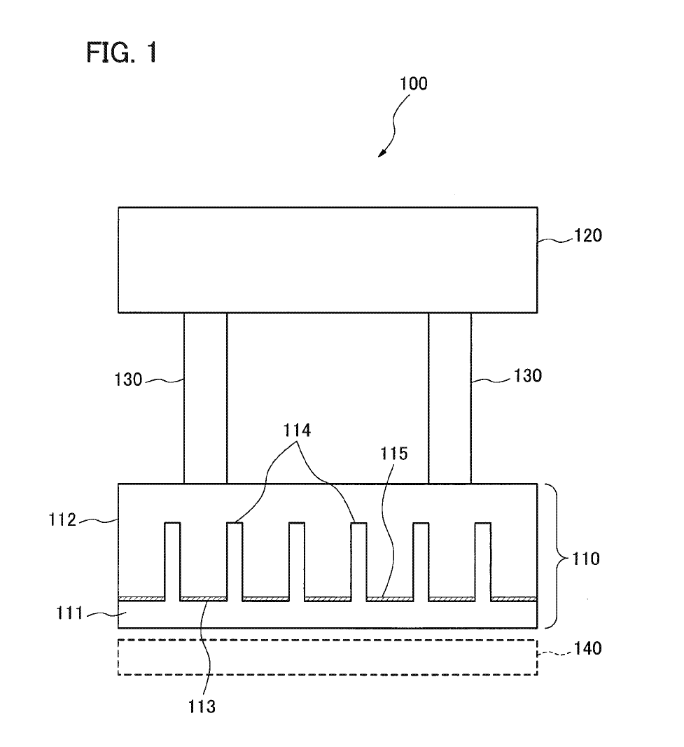

FIG. 1 is a cross-sectional view showing a configuration of a cooling device 100 in accordance with the first exemplary embodiment of the present invention. The cooling device 100 in accordance with the present exemplary embodiment includes an evaporator 110 storing a refrigerant, a condenser 120 condensing and liquefying a vapor-state refrigerant vaporized in the evaporator 110 and radiating heat, and a connection 130 connecting the evaporator 110 and the condenser 120.

The evaporator 110 includes a base 111 thermally contacting with an object to be cooled 140, and a container 112. The base 111 and the container 112 are joined by welding or brazing and the like to form a sealed structure, which stores the refrigerant inside it. The connection 130 is connected to the container 112, and the refrigerant circulates in a vapor-state or liquid-state between the evaporator 110 and the condenser 120 through the connection 130.

After enclosing the refrigerant in the evaporator 110, the evaporator 110 is evacuated. Thereby, the inside of the evaporator 110 is always kept in the saturated vapor pressure of the refrigerant, and the boiling point of the refrigerant becomes equal to room temperature. Therefore, when the object to be cooled 140 produces heat and the heat quantity is transferred to the refrigerant through the base 111, the refrigerant is vaporized and bubbles arise. At that time, since the heat quantity from the object to be cooled 140 is taken away as vaporization heat by the refrigerant, it is possible to avoid rise in temperature of the object to be cooled 140. The vaporized refrigerant flows through the connection 130, is cooled and condensed in the condenser 120, and the refrigerant in liquid-state flows again into the evaporator 110 through the connection 130. It is possible for the cooling device 100 to cool the object to be cooled 140 by the foregoing circulation of the refrigerant without using a driving unit such as a pump.

The base 111 is provided with a plurality of projections 114 on a boiling surface 113 of a surface at an inner wall side contacting with the refrigerant. The projection 114 can be formed in the fin geometry, for example, and it has the effect that the convection heat transfer is enhanced when the bubbles of the refrigerant generated on the boiling surface 113 pass thorough. It is desirable to arrange these projections 114 in an interval in which the convection heat transfer by the bubbles becomes maximized. As the material of the base 111 and the projections 114, it is possible to use the metal having an excellent thermal conductive property such as aluminum, for example.

The evaporator 110 according to the present exemplary embodiment includes a bubble nucleus forming surface 115 only on a part of a refrigerant contacting surface composed of the boiling surface 113 and the surface of the projections 114. A plurality of bubble nuclei, each of which becomes a source nucleus for the bubbles of the refrigerant, are formed on the bubble nucleus forming surface 115, and each of the bubble nuclei has a concavo-convex shape with a projection and a hollow. The optimum value of the size of the concavo-convex shape is determined by considering physical properties such as surface tension of the refrigerant. For example, if hydrofluorocarbon, hydrofluoroether, and the like, which are insulating and inactive materials, are used as the refrigerant, the optimum size of the bubble nucleus is in the range of sub-micron to tens of micrometers in center line average roughness. Therefore, it is possible to form the bubble nuclei by a mechanical processing using abrasive grains, a sandblast, and the like, or by a chemical processing such as a plating. FIG. 1 illustrates a case that the bubble nucleus forming surface 115 is disposed only on the boiling surface 113.

Thus, the cooling device 100 according to the present exemplary embodiment includes the bubble nucleus forming surface 115 on the boiling surface 113 of the base 111 composing the evaporator 110. Therefore, the generation of the bubbles on the boiling surface 113 is activated and the cooling effect is enhanced.

In addition, in the evaporator 110 according to the present exemplary embodiment, the bubble nucleus forming surface 115 is disposed only on a part of the surface of the projections 114. Therefore, the bubbles generated on the surface of the projections 114 decrease. Consequently, it is possible to suppress the phenomenon that the bubbles generated on the projection 114 prevent the bubbles generated on the boiling surface 113 from moving.

Here, the case is considered that the bubble nucleus forming surface is formed on entire surface of the projections 114 in order to increase the number of bubble nuclei, as the related ebullient cooling device described in the background art. Since the temperature of the projections 114 drastically decreases toward the upper part away from the boiling surface 113, the bubble nucleus forming surface disposed at the upper part of the projections 114 hardly contributes to generating the bubbles. That is to say, the contribution to the cooling performance due to the increase in the number of the bubble nuclei is small. Accordingly, the decrease in the total number of the bubble nuclei has a small effect even though the bubble nucleus forming surface 115 is disposed on only a part of the surface of the projections 114.

As described above, according to the cooling device 100 of the present exemplary embodiment, it is possible to obtain a cooling device with an ebullient cooling system whose cooling performance is improved.

As mentioned above, the projection 114 hardly contributes to generating the bubbles, and the effect on the convection of the bubbles generated on the boiling surface 113 becomes dominant in the effects of cooling due to disposing the projection 114. Accordingly, it is possible to determine the interval of the projections 114 so that the convection heat transfer by the bubbles can be maximized taking into account the amount of generation and the rate of generation of the bubbles depending on the amount of heat generation of the object to be cooled 140. For example, if the amount of heat generation is in the range of about 100 W, it is possible to obtain excellent cooling performance on the condition that the interval of the projections 114 is in the range of about 0.1 mm to about 2 mm.

As mentioned above, once the bubbles arise at the projections 114, the flow of the bubbles arising on the boiling surface 113 is prevented. If the flow of the bubbles is prevented, the internal pressure of the evaporator 110 increases and the boiling temperature of the refrigerant which maintains the saturated vapor pressure also increases, therefore the cooling performance deteriorates. However, since the bubble nucleus forming surface 115 is disposed on only a part of the surface of the projection 114 in the evaporator 110 according to the present exemplary embodiment, the generation of the bubbles at the projection 114 is suppressed. Therefore, according to the present exemplary embodiment, it is possible to avoid the above-mentioned deterioration of the cooling performance.

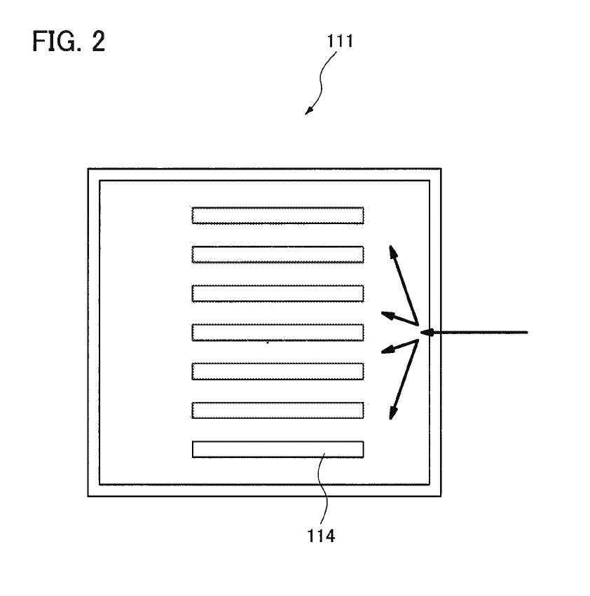

Next, the method for producing the cooling device 100 according to the present exemplary embodiment will be described. FIG. 2 is a plan view of the base 111 which composes the evaporator 110 in the cooling device 100 according to the present exemplary embodiment. The base 111 includes the fin-shaped projections 114 which are located along the direction of the inflow of the refrigerant (in the direction of an arrow in the figure). By arranging the projections 114 along the direction in which the refrigerant flows, the influent refrigerant is able to take the heat away from the projections 114 using the effect of the convection heat transfer without its flow being disturbed. In order to enhance the effect, it is desirable that the projection 114 is configured as a plate-like fin (plate fin).

According to the method for producing the cooling device of the present exemplary embodiment, it is possible to form the projections 114 and the bubble nucleus forming surface in one process including a sequence of steps, as described below. First, the base 111 with the fin-shaped projections 114 is formed by means of the extrusion processing using die and mold.

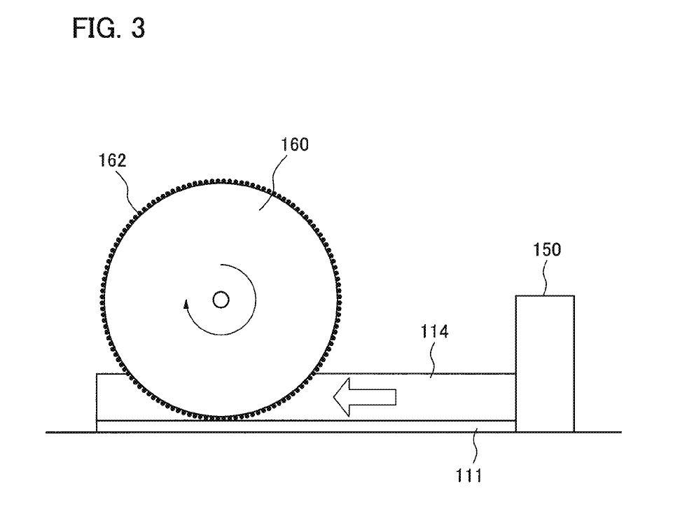

Then, as shown in FIG. 3, the bubble nucleus forming surface is formed by using a rotary forming unit 160 on the base 111 which is extruded from a die 150. The rotary forming unit 160 is cylindrically-shaped and abrasive grains 162 such as diamond micro particles (diamond slurry) and the like are formed on the side surface of the cylinder. The rotary forming unit 160 further includes on the side surface a groove 164 whose width and depth correspond to the width and height of the projection 114.

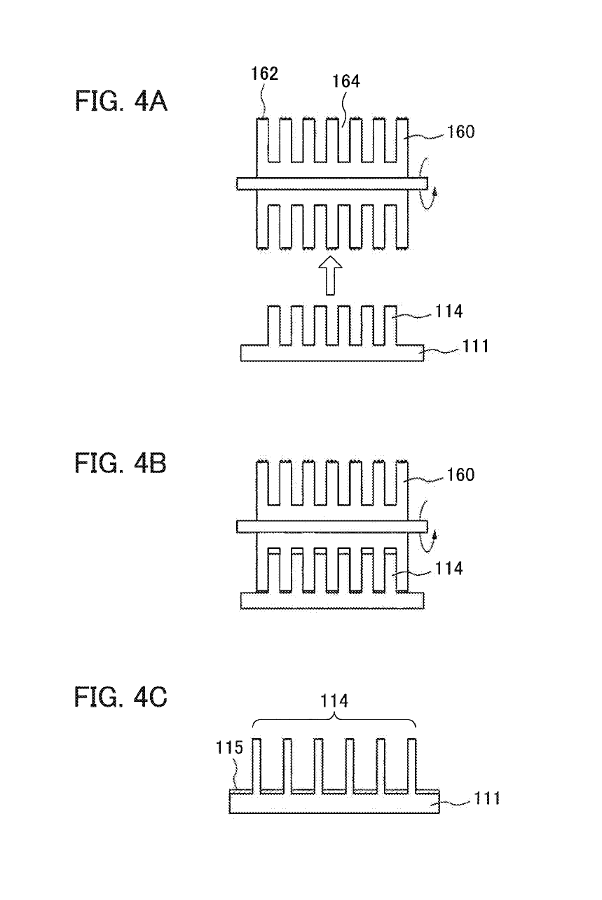

At that time, as shown in FIG. 4A, the projection 114 of the evaporator is inserted into the groove 164 of the rotary forming unit 160, and they are arranged so that the abrasive grain 162 of the rotary forming unit 160 can contact with the surface of the base 111 between the projections 114. Then, as shown in FIG. 4B, by rotating the rotary forming unit 160, the concavo-convex shape corresponding to the shape of the abrasive grain 162 is formed on the surface of the base 111. It is possible to determine arbitrarily the size, shape, and distribution of the concavo-convex shape by specifying the size, shape and the like of the abrasive grain 162. Accordingly, by making the shape of the bubble nuclei determined by the refrigerant properties such as surface tension of the concavo-convex shape, it is possible to form the bubble nucleus forming surface 115 on the surface of the base 111, that is, only on the boiling surface (FIG. 4C). Even though the kind of refrigerant to be used differs, it is possible to form the bubble nucleus forming surface 115 including the bubble nuclei appropriate for the refrigerant to be used by changing the size, shape and the like of the abrasive grain 162 to fit the refrigerant properties.

After that, the base 111 and the container 112 are joined by welding or brazing and the like to form the evaporator 110. Finally the cooling device 100 according to the present exemplary embodiment is completed by connecting the evaporator 110 to the condenser 120 through the connection 130.

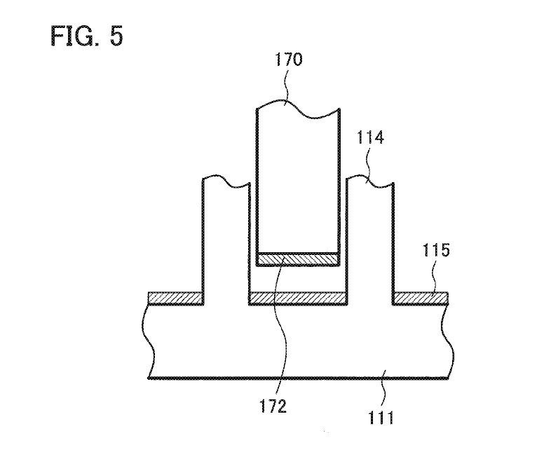

In the above-mentioned method for producing the cooling device, the case has been described that the bubble nucleus forming surface 115 is formed by using the rotary forming unit 160 on which the abrasive grain 162 is formed. However, it is not limited to this, as shown in FIG. 5, it is also acceptable to use a machining die 170 having a machining structure 172 corresponding to the concavo-convex shape of the bubble nucleus, which is disposed at the part of a die used for the extruding method and to form the base 111.

In the related ebullient cooling device described in the background art, the roughening process by the blasting treatment is performed all over the surface of the inner wall side in the evaporator. However, if the roughening process such as etching, plating, and sandblasting is performed with a masking process after forming the convex parts (projections), the production cost increases due to an increase in producing step.

In contrast, according to the method for producing the cooling device of the present exemplary embodiment, since it is possible to perform the roughening process, that is, to form the bubble nucleus forming surface 115 in one process continuous with the process for forming the projections or in the same process as that, it is possible to suppress the increase in the production cost.

### The Second Exemplary Embodiment

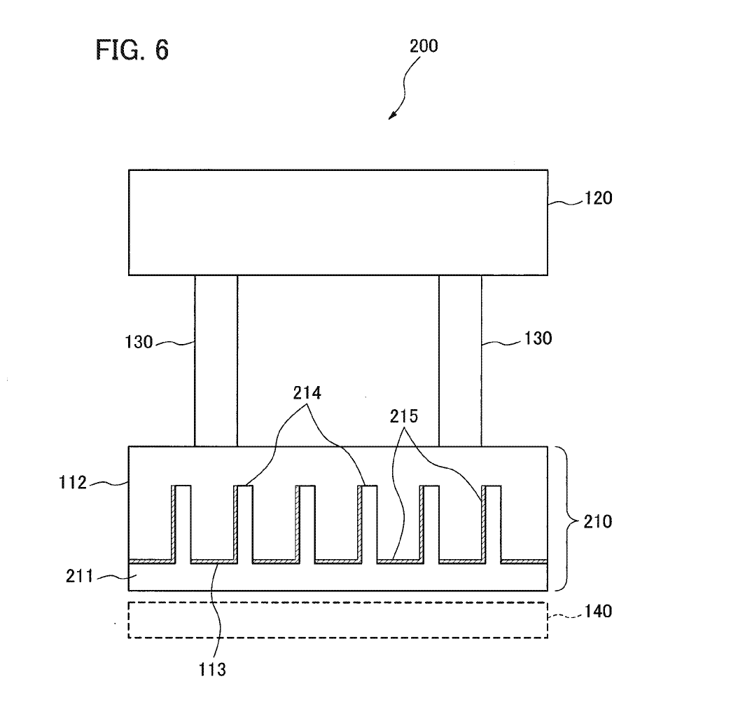

Next, the second exemplary embodiment according to the present invention will be described. FIG. 6 is a cross-sectional view showing the configuration of a cooling device 200 according to the second exemplary embodiment of the present invention. The cooling device 200 according to the present exemplary embodiment includes an evaporator 210 storing the refrigerant, the condenser 120 condensing and liquefying a vapor-state refrigerant vaporized in the evaporator 210 and radiating heat, and the connection 130 connecting the evaporator 210 and the condenser 120.

The cooling device 200 according to the present exemplary embodiment is different from the cooling device 100 of the first exemplary embodiment in the configuration of a bubble nucleus forming surface 215 which is disposed in the evaporator 210. That is to say, as shown in FIG. 6, the evaporator 210 according to the present exemplary embodiment is configured to include the bubble nucleus forming surface 215 only on one of lateral surfaces of projections 214 and the boiling surface 113. The other configurations are the same as those in the first exemplary embodiment, therefore, the descriptions are omitted.

As mentioned above, in the cooling device 200 according to the present exemplary embodiment, the bubble nucleus forming surface 215 is provided on the boiling surface 113 of a base 211 composing the evaporator 210. Therefore, the generation of the bubbles on the boiling surface 113 is activated and the cooling effect is enhanced.

Furthermore, in the evaporator 210 according to the present exemplary embodiment, the bubble nucleus forming surface 215 is disposed on one of the lateral surfaces of the projections 214. Therefore, the bubbles arising from the surface of the projections 214 decrease. As a result, it is possible to suppress the phenomenon that the bubbles generated on the projection 214 prevent the bubbles generated on the boiling surface 113 from moving. As described above, according to the cooling device 200 of the present exemplary embodiment, it is possible to obtain a cooling device with an ebullient cooling system whose cooling performance is improved.

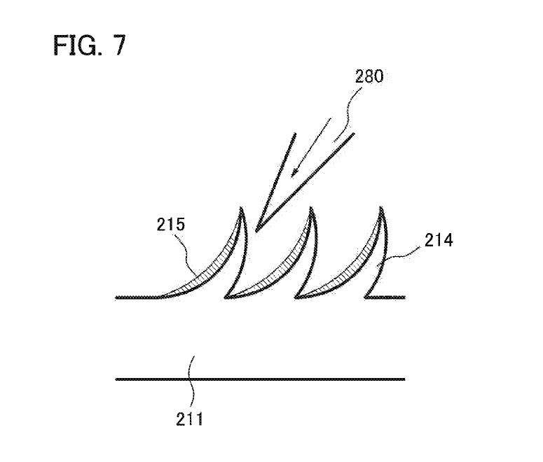

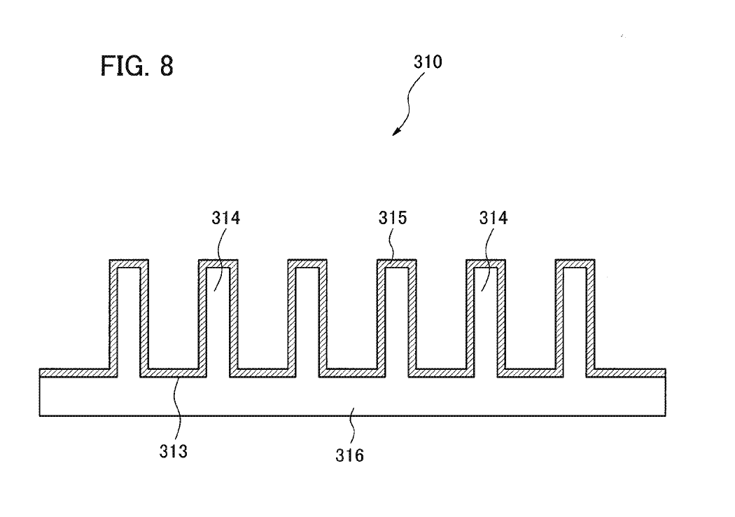

Next, the method for producing the cooling device 200 according to the present exemplary embodiment will be described. FIG. 7 is a cross-sectional view to illustrate the method for producing the cooling device 200 according to the present exemplary embodiment. In the present exemplary embodiment, first, the roughening process is performed all over the surface of the boiling surface, which is the surface of the inner wall side contacting with the refrigerant in the base 211 composing the evaporator storing the refrigerant, and consequently a concavo-convex shape is formed. By making the shape of the bubble nuclei determined by the refrigerant properties such as surface tension of the concavo-convex shape, the bubble nuclei are formed on all over the surface of the boiling surface. It is possible to use a surface treatment such as an alumite treatment and sandblasting, or a chemical processing such as plating process, for the roughening process, for example.

Next, as shown in FIG. 7, a part of the base 211 is carved and raised from the boiling surface side by means of a machining blade 280 used in the stamping process and the like, and consequently the projection 214 is formed in which the roughening process is performed on one side of lateral surfaces. As the result, it is possible to form the bubble nucleus forming surface 215 only on one of the lateral surfaces of the projections 214 and the boiling surface 113 of a bottom surface.

After that, as is the case with the first exemplary embodiment, the base 211 and the container 112 are joined by welding or brazing and the like to form the evaporator 210. Finally the cooling device 200 according to the present exemplary embodiment is completed by connecting the evaporator 210 to the condenser 120 through the connection 130.

According to the method for producing the cooling device of the present exemplary embodiment, since the masking process becomes unnecessary in the roughening process, and additionally it is possible to form the bubble nucleus forming surface 215 without adding any particular equipment, it is possible to suppress the increase in the production cost.

The present invention is not limited to the above-mentioned exemplary embodiments and can be variously modified within the scope of the invention described in the claims. It goes without saying that these modifications are also included in the scope of the present invention.

This application is based upon and claims the benefit of priority from Japanese patent application No. 2010-234359, filed on Oct. 19, 2010, the disclosure of which is incorporated herein in its entirety by reference.

### DESCRIPTION OF THE CODES

100, 200 cooling device
110, 210 evaporator
111, 211 base
112 container
113 boiling surface
114, 214 projection
115, 215 bubble nucleus forming surface
120 condenser
130 connection
140 object to be cooled
150 die
160 rotary forming unit
162 abrasive grain
164 groove
170 machining die
172 machining structure
280 machining blade
310 evaporator
313 boiling surface
314 convex part
315 bubble nucleus
316 inner wall

1. A cooling device, comprising:
an evaporator storing a refrigerant;
a condenser condensing and liquefying a vapor-state refrigerant vaporized in the evaporator and radiating heat; and
a connection connecting the evaporator and the condenser;
wherein the evaporator comprises a base thermally contacting with an object to be cooled, and a container;
the base comprises a plurality of projections on a boiling surface of a surface at an inner wall side contacting with the refrigerant; and
a bubble nucleus forming surface is comprised only on a part of a refrigerant contacting surface comprising the boiling surface and the surface of the projections.

2. The cooling device according to claim 1,
wherein the bubble nucleus forming surface is comprised only on the boiling surface.

3. The cooling device according to claim 1,
wherein the bubble nucleus forming surface is comprised only on the boiling surface and a part of lateral surface of the projections.

4. The cooling device according to claim 1,
wherein the bubble nucleus forming surface comprises a plurality of bubble nuclei, each of which becomes a source nucleus for the bubbles of the refrigerant; and
each of the bubble nuclei comprises a concavo-convex shape with a size determined by properties of the refrigerant.

5. The cooling device according to claim 1,
wherein the plurality of the projections are disposed in an interval in which convection heat transfer by bubbles of the refrigerant becomes maximized.

6. A method for producing a cooling device, comprising the steps of:
forming a plurality of projections on a boiling surface of a surface at an inner wall side contacting with a refrigerant in a base comprised by an evaporator storing the refrigerant;
forming a bubble nucleus forming surface only on a part of a refrigerant contacting surface comprising the boiling surface and the surface of the projections;
forming the evaporator by joining the base to a container; and
connecting the evaporator to a condenser condensing and liquefying a vapor-state refrigerant vaporized in the evaporator and radiating heat.

7. The method for producing the cooling device according to claim 6, further comprising:
forming the projections by using an extruding method;
forming the bubble nucleus forming surface by using a rotary forming unit;
wherein the rotary forming unit comprises, on a side surface of a cylinder, a groove whose width and depth correspond to the width and height of the projection, and abrasive grains are formed on the side surface;
arranging the rotary forming unit so that the abrasive grain can contact with a surface of the base between the projections, and forming the bubble nucleus forming surface with a concavo-convex shape corresponding to the shape of the abrasive grain on a surface of the base by rotating the rotary forming unit; and
performing a step for forming the projections and a step for forming the bubble nucleus forming surface in a continuous process.

8. The method for producing the cooling device according to claim 6, further comprising:
forming the projections by using an extruding method;
using a machining die having a machining structure corresponding to a concavo-convex shape of a bubble nucleus, which is disposed at a part of a die used for the extruding method and to form the base;
performing a step for forming the projections and a step for forming the bubble nucleus forming surface in a continuous process.

9. The method for producing the cooling device according to claim 6,
wherein the bubble nucleus forming surface comprises a plurality of bubble nuclei, each of which becomes a source nucleus for the bubbles of the refrigerant; and
each of the bubble nuclei comprises a concavo-convex shape with a size determined by properties of the refrigerant.

10. A method for producing a cooling device, comprising the steps of:
performing a roughening process on a boiling surface of a surface at an inner wall side contacting with a refrigerant in a base comprised by an evaporator storing the refrigerant;
forming a bubble nucleus comprising a concavo-convex shape with a size determined by properties of the refrigerant;
forming a projection by carving and raising a part of the base from the boiling surface side;
forming the evaporator by joining the base to a container; and
connecting the evaporator to a condenser condensing and liquefying a vapor-state refrigerant vaporized in the evaporator and radiating heat.
